(19) United States
(12) Patent Application Publication
(10) Pub. No.: US 2021/0354371 A1
(43) Pub. Date: Nov. 18, 2021

(54) STORAGE TANK LOADING

(71) Applicant: HEWLETT-PACKARD DEVELOPMENT COMPANY, L.P., Spring, TX (US)

(72) Inventors: Miguel Vega Velasco, Sant Cugat del Valles (ES); Pedro Garcia Garces, Sant Cugat del Valles (ES); Alejandro Torres Pinero, Sant Cugat del Valles (ES)

(21) Appl. No.: 16/607,770

(22) PCT Filed: Jun. 5, 2018
(86) PCT No.: PCT/US2018/036118

§ 371 Date: Oct. 24, 2019

(51) Int. Cl. B29C 64/153; B29C 64/255; B29C 64/314; B29C 64/336; B29C 64/357; B29C 64/393; B33Y 10/00; B33Y 30/00; B33Y 40/10

(52) U.S. Cl. CPC B29C 64/153; B29C 64/255; B29C 64/314; B29C 64/336; B33Y 40/10; B29C 64/393; B33Y 10/00; B33Y 30/00; B29C 64/357

(57) ABSTRACT

Certain examples relate to a storage tank loading system for loading powdered build material to a storage tank and generating a quality indicator. In these examples, the quality indicator may be generated by comparing a measured color with at least one predetermined threshold value, in these examples, the color of powdered build material is determined by a color sensor.

### BACKGROUND

Additive manufacturing processes can produce three-dimensional (3D) objects by solidifying and unifying successive layers of build material in cross-sectional patterns of the 3D objects according to computer models. Successive layers can be solidified and unified using processes such as melting, sintering, irradiating, applying agents, or combinations of these processes. Structural and decorative properties of 3D objects built in additive manufacturing processes may be controllable and may depend on the process and materials used.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1a is a schematic diagram of a storage tank loading system according to examples;

FIG. 1b is a schematic diagram of a color sensor disposed on a hose of a powdered build material transportation system according to examples;

FIG. 2 is a schematic diagram of a storage tank loading system comprising a mixing system according to examples;

FIG. 3 is a schematic diagram of a non-transitory computer readable storage medium according to examples;

FIG. 4 is a flow chart showing a method according to examples.

### DETAILED DESCRIPTION

Additive manufacturing systems may generate 3D objects in a multitude of ways. One such way, using powdered build material, is to deposit successive layers of powdered build material and to solidify a portion of the layers. This process may also be referred to as printing 3D objects. The portion of each layer which is solidified corresponds to a cross section of the object to be generated, such that as each successive layer is solidified and unified with the previous layer the sum of all the cross sections generates the object. Powdered build material may be solidified by the application of energy, such as electromagnetic radiation. Energy may be applied in a focused manner to the portion of the build material which is to be solidified. In some examples, agents may be deposited onto the build material to facilitate the solidification of the portion of build material. Some agents are deposited to the portion of build material to be fused and then energy may be applied evenly across the layer of build material such that the portions of build material on which agents have been deposited may fuse while other portions remain un-fused, Through this disclosure agents which are used in this way will be referred to as fusing, or coalescing, agents. Some agents may absorb the energy applied to the build material to heat the portions of build material to the point of sintering or fully melting.

According to one example, a suitable fusing agent may be an ink-type formulation comprising carbon black, such as, for example, the fusing agent formulation commercially known as V1Q60Q “HP fusing agent” available from HP Inc. In one example such a fusing agent may additionally comprise an infra-red light absorber. In one example such an ink may additionally comprise a near infra-red light absorber. In one example such a fusing agent may additionally comprise a visible light absorber. In one example such an ink may additionally comprise a UV light absorber. Examples of inks comprising visible light enhancers are dye based colored ink and pigment based colored ink, such as inks commercially known as CE039A and CE042A available from HP Inc.

In other examples of additive manufacturing systems, the agents deposited to powdered build material may be chemical binding agents. In these cases, the chemical binding agents cause the portions of powdered build material on which they are deposited to solidify. Energy may be applied to the build material after this solidification to further harden the solidified material. Other agents may also be applied to powdered build material to modify the solidification or fusion. For example, some agents, for example detailing agents, may be applied to reduce the strength of the fusing caused by fusing agents and the applied energy. This may allow some parts of the objects which are generated to be, for example, more flexible than other parts. Other agents may be used to modify the color, transparency, conductivity, or any other material property of the objects. According to one example, a suitable detailing agent may be a formulation commercially known as V1Q61A “HP detailing agent” available from HP Inc.

Powdered build material may be used to refer to wet or dry powder, particulate materials, and granular materials. Powdered build material may be made from many suitable materials, for example, powdered metallic materials, powdered composite materials, powdered ceramic materials, powdered resin materials, powdered glass materials, powdered polymer materials and the like. According to one example, a suitable material may be a PA12 build material commercially known as V1R10A “HP PA12” available from HP Inc.

In some examples, powdered build material may be formed from, or may comprise, short fibers that may, for example, have been cut into short lengths from long strands or threads of material. Short fibers may be metallic fibers, polymer fibers, ceramic fibers, or other suitable fiber materials.

Some additive manufacturing processes may comprise, after generating objects, recovering the objects from within the layers of un-fused build material. In these cases, un-fused build material may be extracted and stored for use again in another additive manufacturing process. Some of the powdered build material may be recycled multiple times. In processes where energy may be evenly applied to each successive layer of build material, un-fused material may be heated in excess of 150° C., and in some processes in excess of 180° C. For example, PA12 may be heated in excess of 180° C. The temperature to which build material may be heated may depend on the type of build material being used. For example, powdered metallic materials may be heated to greater temperatures than powdered polymer materials. The heating and cooling of un-fused build material may affect the chemical structure of the build material. In processes where build material is recycled, repeated heating and cooling of build material can begin to alter the chemical structure of the build material such that it may become less effective for use in an additive manufacturing system. For example, objects built using build material which has been heated and cooled repeatedly may lack the structural integrity of objects which are built using fresh or un-recycled build material. The higher the temperature which build material is heated to, the faster the build material may degrade.

Some powdered build materials, as they degrade due to repeated heating and cooling processes, may change color. For example, some powdered polymer build materials change from white to brown as they degrade, such as HP® 3D High Reusability PA 12. The browner the color of the powdered polymer build material, the more degraded it is. This change in color may provide an indication of the overall quality of the powdered build material. The degradation of powered build material may affect the powdered build materials ability to fuse, to accept agents for solidification (coalescing or chemical binding), or the ability to be colored by the deposition of colorants.

Variables of an additive manufacturing build process may affect the degree or speed of degradation. For example, some additive manufacturing processes build objects within a volume defined by the walls of a build bin. Some users may try to maximize the number of objects which are printed in a single build process in order to reduce the time needed to print a given number of objects. To do this the additive manufacturing build process data may pack the objects within the volume very closely. Un-fused build material between tightly packed objects may be heated to a greater temperature during a print process than un-fused build material having more un-fused material around it. This means that tightly packing objects in an additive manufacturing build process may increase the speed at which un-fused build material may degrade and therefore may reduce the efficiency in terms of use of powdered build material.

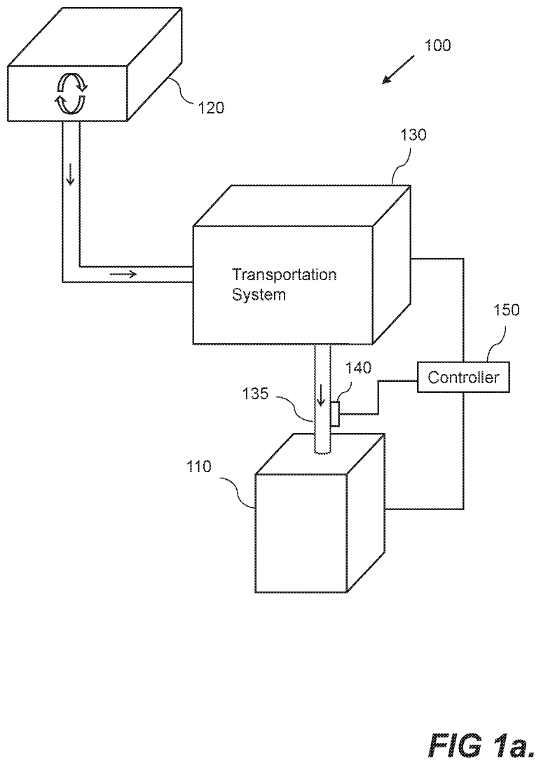

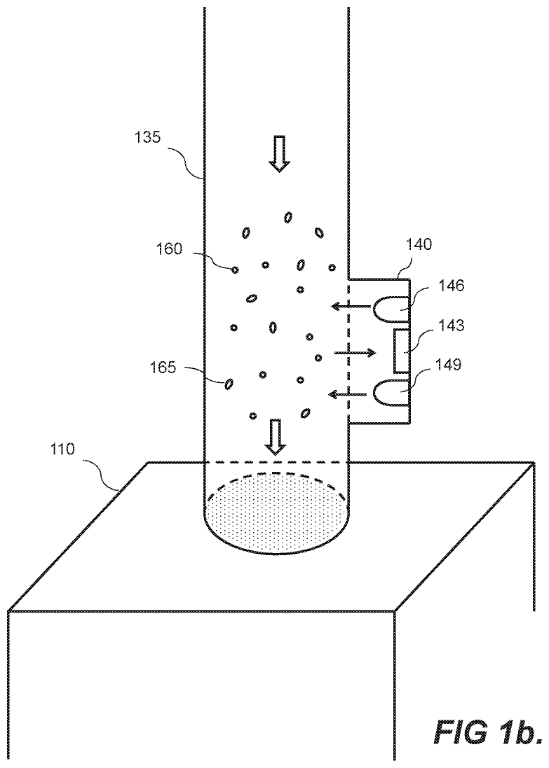

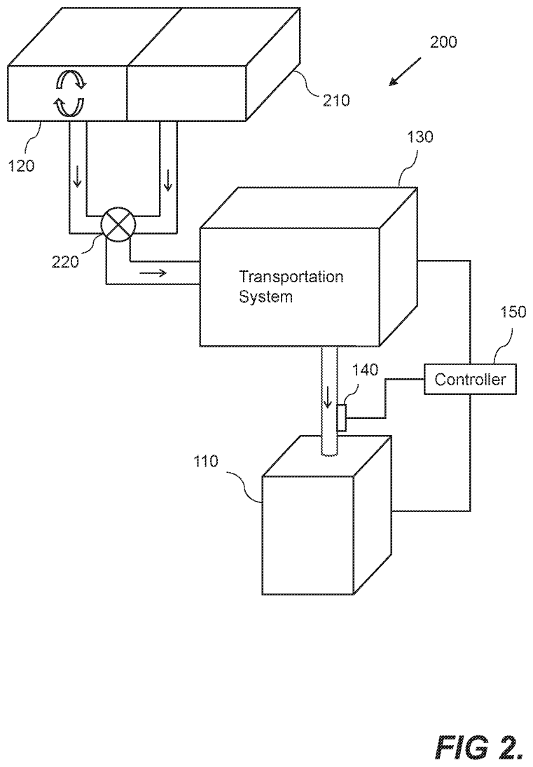

Certain examples described herein provide a system for determining the quality of powdered build material which has been loaded into a storage tank. FIGS. 1a and 2 show examples of such a system. A storage tank may be used to load powdered build material into an additive manufacturing printer or may be part of a build bin, wherein the build bin may define the volume in which the objects are printed during an additive manufacturing process, wherein an additive manufacturing process is the same as a print process. A color sensor may be used to determine the color of powdered build material loaded into the storage tank and an indicator of the quality of this powdered build material may be generated. FIG. 1b shows an example of a color sensor measuring the color of powdered build material. The quality indicator may be sent to electronic memory. The electronic memory may be associated with the storage tank. This may allow the quality indicator to be accessed later to determine the quality of build material stored in the storage tank. The electronic memory may be at the storage tank. This may allow the storage tank to store an indication of the quality of powdered build material stored within it. Certain other examples described herein discuss a non-transitor), computer readable storage medium. The storage medium may comprise instructions to be executed by a processor which cause the processor to execute the loading of powdered build material into a storage tank and to determine the quality of the powdered build material.

Certain examples described herein provide a method of loading powdered build material into a storage tank. The method comprises determining the quality of the powdered build material loaded into the storage tank by measuring the color of the powdered build material. An indication of the quality is generated and sent to electronic memory associated with the storage tank. This may allow the indication of the build material's quality to be stored and accessed later.

Returning to FIG. 1a, an example of a storage tank loading system 100 for loading powdered build material to a storage tank 110 is shown. The storage tank loading system 100 in FIG. 1a comprises a powdered build material tank 120 for storing un-fused powdered build material. The un-fused powdered build material may have been used in an additive manufacturing process. The powdered build material tank 120 may comprise electronic memory which may store an indication of the quality of the powdered build material stored within the tank 120. The powdered build material tank 120 may be filled with powdered build material through an inlet or valve. In some examples the powdered build material tank 120 comprises a filtering system in front of or after any or all inlets to the tank 120. The filtering system may comprise a fine mesh, a filter which utilizes cyclonic separation, or any other filtering device to reduce the likelihood of any fused or partially fused particles from entering or leaving the powdered build material tank 120. The powdered build material tank 120 may be refillable or may be a single use tank preloaded with un-fused powdered build material for loading into a storage tank 110.

The storage tank loading system 100 according to the example shown in FIG. 1a may comprise a powdered build material transportation system 130 for transporting un-fused powdered build material. The transportation system 130 may transport un-fused powdered build material from at least the powdered build material tank 120 to a storage tank 110. The powdered build material transportation system 130 is shown as a cuboid structure with pipes entering and leaving the system 130. The transportation system 130 may transport powdered build material using by inducing air pressure in the system 130 using any number of valves, hoses, motors, pipes, and pressure sources such as pumps. The pipes shown in FIG. 1a may connect to the storage tank 110 and to the powdered build material tank 120 using seals, valves, purpose fit connectors, or any suitable attachment mechanism which allows powdered build material to be transported from within tank 120 to tank 110.

The storage tank loading system 100 may comprise a color sensor 140 for detecting the color of at least part of the un-fused build material transported to the storage tank 110 by the powdered build material transportation system 130. In the example shown in FIG. 1a, the color sensor 140 is disposed on an outer side of a hose 135 of the transportation system 130. The color sensor may be disposed on an optically transmissive part of the hose such that it can measure the color of powdered build material within. The color sensor 140 is disposed towards the end of the transportation system 130, where the hose 135 connects to the storage tank 110 in which powdered build material is being deposited, This may allow the color sensor 140 to measure the color of powdered build material which is travelling into the storage tank. If the color sensor 140 was positioned earlier in the transportation system 130, there is a greater possibility of the powdered build material which is measured by the color sensor 140 being trapped or lost within the transportation system 130 before reaching the storage tank 110. Therefore, the measurements would not be an accurate representation of the powdered build material being stored within the storage tank 110. The color sensor 140 will be discussed in further detail in relation to FIG. 1b.

In some examples, the color sensor 140 may be positioned at the storage tank 110, for example, within the storage tank 110, or at the connection between the storage tank 110 and the hose 135. This may allow the color of the powdered build material to be sensed after the powdered build material has been transported to the storage tank 110.

In other examples, the color sensor 140 may be positioned at an outlet of the powdered build material tank 120 or before the transportation system 130. The powdered build material when transported through the system 130 may have a greater density at these positions and thereby may allow a more accurate measurement of color with the color sensor 140.

In some examples the storage tank loading system 100 comprises a controller 150. A controller 150 may be implemented as any combination of program code and hardware suitable to perform the functions described herein. For example, the controller 150 may comprise a processor, or processors, to implement instructions stored on a storage medium. The controller 150 may receive signals from the color sensor 140 indicative of the color of at least part of the un-fused powdered build material transported to the storage tank 110. In the example of Figure la a wired connection is shown between the color sensor 140 and the controller 150. This may allow signals generated at the color sensor 140 to be directly sent to the controller 150 for processing. In some examples, the color sensor 140 and the controller 150 communicate wirelessly and may comprise any number of wired or wireless communication devices.

The controller 150 may generate a quality indicator by comparing the signals received from the color sensor 140 with at least one predetermined threshold value. In some examples, a quality indicator may be a binary indicator stored in electronic form which specifies either good or bad quality. In other examples the quality indicator may be a non-binary indication of the suitability of the powdered build material to be used in an additive manufacturing process. For example, a quality indicator may specify one of a plurality of possible grades for example, four grades of quality. The number of possible grades may depend on the sensitivity of the color sensor 140 as will be discussed in relation to FIG. 1b. The at least one predetermined threshold value may be determined by calibrating the storage tank loading system 100 using powdered build material for which the quality has been determined.

The storage tank 110 may comprise electronics such as non-transitory computer readable memory for example, a hard drive, a CD-ROM disc, a USB-drive, a solid-state drive or any other form of magnetic storage device, optical storage device, or flash memory device. In some examples, the controller 150 may send the quality indicator to electronic memory. The electronic memory may be associated with the storage tank. This may allow the quality indicator to be stored such that the quality of the powder in the storage tank 110 can be checked later. In some examples the electronic memory is at the storage tank 110. This may allow the storage tank full of powdered build material to be directly associated with the quality of the powdered build material currently within the tank. In some examples the sent quality indicator overwrites any previously stored quality indicator.

In some examples, storage tanks are part of build bins or may be referred to as build bins. A build bin may be a device in which objects are generated during an additive manufacturing process. Build bins may comprise support plates to receive powdered build material. Powdered build material may be deposited to a support plate which may retract into a volume defined by the build bin to allow successive layers of powdered build material to be deposited onto previous layers. As portions of each layer are solidified and unified with previous solidified portions, objects may be formed by the build material received within the build bin. The powered build material, before being deposited to the receiving plate, may be stored in a powdered build material reservoir of the build bin. This may allow a build bin to be inserted to an additive manufacturing printer with the right amount of powdered build material to perform a build process. Thereby allowing the correct amount of build material to be inserted for each build process. The build bin may then be removed from the additive manufacturing printer and a fresh build bin storing build material can be inserted into the printer to perform a second build process. Build bins may comprise any number of computing devices including a user interface to allow a user to select properties of the build bin and to provide a user with information relating to the build bin or the material and/or objects within the build bin.

FIG. 1b shows a close-up of the hose 135 of the powdered build material transportation system 130 which is connected to the storage tank 110 to deposit powdered build material to the storage tank 110, In this example the color sensor 140 is for detecting the color of at least part of the un-fused powdered build material in the hose 135 of the powdered build transportation system 130, This allows the color of the powdered build material to be measured just before it enters the storage tank 110, thereby ensuring that the build material which is measured is the build material which is stored in the tank 110. The hose 135 may be connected to the storage tank 110 by a connection device which facilitates the transfer of powdered build material from the transportation system 130 into the storage tank 110. For example, the hose may connect to a one-way valve such that powdered material can enter the storage tank 110 but cannot travel backwards into the transportation system 130. This may be useful when pressure sources are used to transport powdered build material and there is a risk of turbulent pressure mixing powdered material having been loaded to the storage tank 110 with powdered build material in the transportation system 130.

The color sensor 140 may be disposed on an outer side of an optically transmissive part of the hose 135. This is shown as broken lines in FIG. 1b representing an optically clear side wall which allows the passage of light therebetween. The color sensor 140 may comprise a color light-to-frequency converter 143. An example of a color light-to-frequency converter may be a TCS3200 or a TCS3210 programmable color light-to-frequency converter available from Texas Advanced Optoelectronic Solutions® (TAOS). The color light-to-frequency converter 143 may be used to detect the color objects passing in front of the sensor. In order to measure the color, a color light-to-frequency converter 143 may be used in conjunction with at least one LED. In FIG. 1b, two LEDs are shown 146 and 149, These LEDs are positioned such that they shine light through the optically clear wall on the side of the hose 135 and powdered build material 160, 165 within the hose will reflect a portion of the light back towards the color light-to-frequency converter 143. The color light-to-frequency converter 143 may translate the reflected light into voltage and frequency outputs. The output signals will be related to the color of the powdered build material in the hose 135 from which the light was reflected. These signals may be output to the controller 150 which may then compare the values of voltage and frequency with predetermined values to determine the quality of the build material. In some examples, the color sensor operates in the visible wavelength between 400 and 700 nanometers. In other examples, the color sensor may operate beyond the visible spectrum. Other color sensors apart from color light-to-frequency converters may be used to detect the color of build material in the hose 135 for example, a charge-couple device (CCD) may be used to record digital images which may the be processed to determine the color of powdered build material. Other color sensors may use other light sources such as lasers, fiber optics, and halogen lamps.

FIG. 1b shows a sample of powdered build material travelling in the hose 135. The sample of powdered build material travelling in the hose 135 comprises a mixture of less degraded 160 and more degraded 165 powdered build material. In some examples of powdered build material, (e.g. Vestostint® 3D Z773 PA 12 or HP® 3D High Reusability PA 12) as the powdered build material degrades the molecules of the material increase in size. This may affect the viscosity of the powdered build material. During print processes, not all powdered build material degrades at the same rate, for example, the position within the volume and the number of times the build material has been recycled affect the speed and severity of degradation. In other cases, powdered build material which is to be loaded into a storage tank 110 may be a mixture of fresh and recycled powdered build material. For example, 20% fresh material and 80% recycled material. As multiple grades of powdered build material quality may be present in the transportation system 130 during the loading of the storage tank 110, the color sensor may detect an average quality based on the average reflected light from the powdered build material.

In some examples, the color sensor 140 continuously measures the color of the powdered build material in the hose 135 as it is loaded to the storage tank 110. In examples such as these, the controller 150 may continuously receive the signals from the color sensor 140 indicative of the color of the powdered build material. The controller 150 may store the measurements of color of powdered build material such that once the storage tank 110 is fully loaded with powdered build material, an average of the measurements of color may be used to determine an average overall quality of powdered build material stored in the storage tank 110. In other examples, the color sensor 140 may be used to take measurements at regular intervals or at specific times during the loading process for example, when the storage tank 110 is 25% full, 50% full, 75% full. The storage tank 110 may comprise sensors which can communicate with the controller 150 such that the controller 150 can record measurements of the color of powdered build material at these stages. These values may then be averaged to determine an average value of the quality of the powdered build material stored in the storage tank 110.

As the powdered build material passing through the transportation system 130 is particulate, consideration may be given to the flow of the powdered build material passed the color sensor 140 such that there is sufficient material passing the color sensor 140 for accurate and reliable measurements of color to be made. Flow may relate to the density and speed at which powdered build material is passed through the transportation system 130. The accuracy of color measurements may be increased by providing an absorbent, non-reflective coating to the inside of the transportation system 130 particularly near the part of the transportation system 130 where the color sensor 140 is positioned. In examples where the color sensor 140 measures reflected light, the inside of the hose may be coated in a non-reflective paint such that a majority of the reflected light measured by the color sensor 140 is reflected from the powdered build material. In some examples, the hose may comprise a non-reflective material. In examples using different color sensors or different color sensing techniques, different methods may be used to ensure accurate measurement of the powdered build material. For example, color measurements may be made by analyzing transmission of light rather than reflection.

FIG. 2 shows an example of a storage tank loading system 200 similar to the system 100 of Figure la but further comprising a powdered build material tank 210 for storing un-fused powdered build material not having been used in an additive manufacturing process. In some additive manufacturing systems, powdered build material which has been recycled or which has begun to degrade may be mixed with unused or higher quality powdered build material to reduce the effects of using degraded powder in a build process. In some examples fresh build material and recycled build material are mixed in a ratio of 1:4 respectively. In some examples, recycled powdered build material may be mixed with less degraded recycled powdered build material.

The example storage tank loading system 200 shown in FIG. 2 comprises a mixing system 220. The mixing system 220 may mix un-fused powdered build material from the powdered build material tank 120 for storing un-fused powdered build material having been used in an additive manufacturing process with unfused powdered build material from the powdered build material tank 210 for storing un-fused powdered build material not having been used in an additive manufacturing process.

The mixing system 220 may comprise two inlets, for example, one from each powdered material storage tank, and an outlet for passing mixed material to the transportation system 130. The mixing system 220 may comprise a rotary blade to mix powdered build material received from each of the powdered build material storage tanks 120, 210. In some examples there are more powdered build material tanks comprising powdered build material of the same or different quality. Accordingly, the mixing system 220 may have a different number of inlets and outlets. In some examples the mixing system 220 sends the mixed build material to a powdered build material tank further down the line for storing mixed powdered build material. Other methods of mixing or blending build material may be possible. The powdered build material tank 120 may be used to store mixed material.

In some examples, the color sensor 140 may be disposed at the outlet of the mixing system 220. This may allow the quality of the mixed build material to be determined at the output of the mixing system 220, such that the mixing ratio may be dynamically controlled to cause the build material, output from the mixing system 220, to be above a desired minimum quality. In other examples, positioning the color sensor 140 at an outlet of the mixing system 220 may allow the mixing ratio to minimize the amount of fresh build material being used whilst still maintaining a particular quality of powdered build material, therefore increasing the efficiency of the recycling of powdered build material. In other examples, there may be at least one color sensor disposed at the outlet of each tank 120, 210.

In some examples, the storage tank loading system 100, 200 may comprise a user interface to display the quality indicator to a user. A user interface may comprise any device which capable of displaying information to, and in some examples receiving information from, a user. For example, a touch screen, an LED light, user operable buttons, or any other suitable device or equipment. In some examples, the storage tank 110 may comprise a user interface.

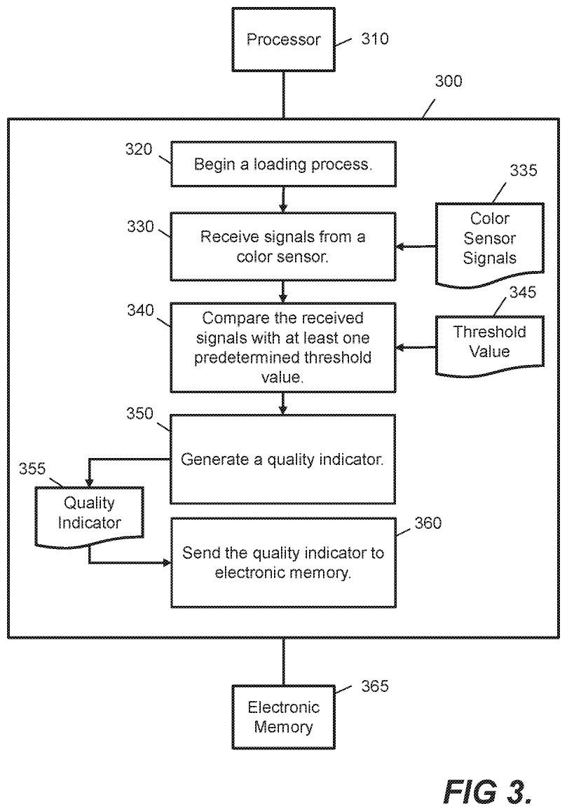

FIG. 3 shows schematically an example of a non-transitory computer readable storage medium 300 storing instructions. The instructions when executed by a processor 310, cause the processor 310 to perform the operations described below. A first set of instructions 320 may cause the processor 310 to begin a loading process. The loading process may be to load powdered build material into a storage tank wherein at least a portion of the powdered build material has been used in an additive manufacturing process, This may comprise sending signals to a build material transportation system. A transportation system may transport un-fused powdered build material from a powdered build material tank to the storage tank. The build material transportation system may comprise any number of valves, pumps, motors, filters, switches, or any other mechanical or electromechanical device which can be used to transport powdered build material from one tank to another. The signals sent to the transportation system by the processor may be used to control devices within the transportation system to control the transport of powdered build material. For example, the signals may specify or control the power transferred to pumps to control the flow rate of powdered build material. The signals may comprise signals sent to valves to cause the valves to open and/or close to route powdered build material through the transport system. The signals may dictate the speed and volume of transport of powdered build material. In some examples, beginning a loading processes may comprise sending signals to a mixing system. The signals may specify the mixing ratios between powdered build material from two different tanks. In some cases, one of the tanks, from which powdered build material is mixed, stores recycled build material and the other tank may store fresh or un-used build material. The mixing system may control the rate at which mixing is performed, the ratio of the mixing, and the volume of powdered material which enters the transportation system. In some examples, beginning a loading process may also include performing checks such as ensuring that a hose of the transportation system is connected to the storage tank. In examples where the hose and the storage tank engage mechanically, there may also be an electrical connection which allows the processor to send and/or receive test signals to ensure the hose is correctly engages with the storage tank. In some examples, beginning a loading process may comprise sending at least one signal to a color sensor to select a color measurement operation and/or to begin a color measurement.

A second set of instructions 330 may cause the processor 310 to receive signals 335 from a color sensor. The signals 335 received from the color sensor may be indicative of the color of the powdered build material being loaded to the storage tank. Receiving the signal 335 may comprise some processing of the signal 335. For example, passing the signal 335 through any number of analogue or digital electronic components such as amplifiers or filters to modify the signal 335. In examples where the color sensor comprises a programmable color light-to-frequency converter, the received signals 335 may comprise frequency and voltage information related to the irradiance and wavelength of the light received at the color light-to-frequency converter. In some examples a color sensor may comprise a light source, for example, at least one LED, directed at an object for which the color is to be measured. The reflected light is then measured to determine the color of the object. Other color sensor may be used to detect the color of powdered build material. In examples using other color sensors, the received signals 335 may be different or may comprise different information but will be related to the color of the powdered build material. As discussed above the color sensor may be placed somewhere along the transportation system with a view of the powdered build material. For example, the color sensor may be attached to an optically clear wall at a hose with a view of powdered build material as it passes through the hose. The optically clear wall may be transparent but colored and filters may be applied to the color sensor or calibration of the color sensor may be performed to eliminate inaccuracies due to this. Positioning the color sensor outside of the hose may protect the sensor from being damaged by the passing powdered build material which may erode components on the sensor.

A third set of instructions 340 may cause the processor 310 to compare the received signals 335 with at least one predetermined threshold value 345. In some examples the predetermined threshold value 345 may relate to a value in the same form as the received signals 335. For example, where the received signals 335 are voltage and frequency signals which are related to color the at least one predetermined threshold value 345 may comprise voltage and frequency information. The comparison of the received signals 335 with the at least one predetermined threshold value 345 may be to determine a powder quality value of the powdered build material being loaded into the storage tank. For example, the received signals 335 may be compared to the predetermined threshold value 345 and if the frequency of a signal is below a predetermined threshold frequency the powder may be assigned a quality value. If the frequency of a signal is above the predetermined threshold frequency the powder may be assigned a different quality value. In some examples there are multiple predetermined threshold values 345. Received signals 335 may be compared with multiple predetermined threshold values 345 to determine the quality of the powder which has been measured. The predetermined threshold values 345 may define ranges. For example, if a variable of a received signal is compared with a first threshold value and a second threshold value and lies between the two threshold values the powder for which that received signal relates may be assigned a quality value related to that range,

With the powdered build material having been loaded into the storage tank, a fourth set of instructions 350 may cause the processor 310 to generate a quality indicator 355 for the powdered build material loaded to the storage tank. The quality indicator 355 may be based on the powder quality value. In some examples the quality indicator 355 may be generated by averaging more than one powder quality value. For example, a powder quality value may be generated multiple times during a loading process. A powder quality value may be generated at each of a series of stages for example, when the storage tank is 33% full, 66% full, and 99% full. Alternatively, a color sensor may continuously measure color during a loading process and powder quality values may be continuously generated. In some examples, the quality indicator 355 may be a binary indication of quality wherein one value represents good quality and the other represents poor quality. The quality indicator 355 may comprise more information, for example, a usability recommendation for the powder such as “use for design parts”, “good to use”, or “do not use”, wherein design parts may not be used for their mechanical properties, for example, for load baring parts. However, as degraded powder changes color, design parts which are to be colored may avoid the use of recycled powdered build material.

In some examples the quality indicator 355 may be a non-binary indicator of the suitability of the powdered build material loaded into the storage tank to be used in an additive manufacturing process, In examples where received signals are compared to one predetermined threshold value a binary quality indicator 355 may be generated. Whereas, in examples where the received signals are compared to multiple predetermined threshold values, a non-binary quality indicator 355 may be generated,

A fifth set of instructions 360 may cause the processor 310 to send the quality indicator to electronic memory 365 associated with the storage tank. The processor 310 may send the quality indicator 355 to electronic memory 365 at the storage tank. Sending the quality indicator 355 to electronic memory 365 at the storage tank may allow the storage tank to store an indication of the quality of the powdered build material stored within the storage tank. This may allow the build quality indicator 355 to be directly associated with the powdered build material in the storage tank.

In some examples, a powdered build material tank, from which build material is loaded to a storage tank, may store recycled material having been extracted from a build bin, wherein the build bin and the extracted material has been used in an additive manufacturing process. The storage tank in which this build material is to be loaded may be a storage tank in the same build bin from which it was extracted. In examples such as these, the storage tank and/or build bin may comprise electronic memory 365 to store information relating to the number of print processes having been performed since fresh material was added to the build bin. This may allow a determination as to whether the packing of objects within the build bin during a print process is contributing to accelerated degradation of build material as discussed earlier. If powdered build material has degraded significantly in a single print process the packing of objects may be contributing to this. The quality indicator may comprise information such as this, allowing the system to inform a user as to whether additive manufacturing build process data relating to the objects to be printed should be modified to ameliorate the degradation of powdered build material.

As the storage tank is moved to a 3D printer to begin a print process the memory on the storage tank may be accessed to provide the quality indicator 355 to the printer. This may allow users to make informed decision about whether to use the recycled material in the storage tank for a given print process. Print processes which are to generate objects which are load bearing or have structural significance may be printed using high quality powdered build material to ensure that the objects produced are suitable for the intended use. In some examples, the printer may determine based on the quality indicator whether to begin a print process using the build material stored in the storage tank.

In some examples, a sixth set of instructions may cause the processor 310 to send the quality indicator to a user interface for displaying the quality indicator. This may provide a user with an immediate indication of the quality of the powdered build material in the storage tank before having to move the storage tank to a 3D printer for printing.

The at least one predetermined threshold value may be generated in a calibration process. As the color sensor may be positioned in a very specific position in the system and the flow of the powdered build material will affect the readings, the calibration may comprise passing test samples through the system. At least one predetermined threshold value may be generated by beginning a loading process using powdered build material having a predetermined quality. Many samples of powdered build material may be collected and rated from highest to lowest quality. For example, powdered build material may be collected from multiple processes and ranked in terms of color, in the case of the powdered polymers discussed above this may be from white to brown. Samples of these color ranked samples may then be tested in additive manufacturing processes and the quality of the objects produced may be used to rank the quality of the different colors of build material. Chemical and physical tests may also be used directly on the powder. In some examples, the melt flow index (MFI) is measured for a range of different colors of powdered build material and the MA value is used to rate the powdered build material. MR is inversely proportional to the viscosity and so provides a good indicator of usability of powdered build material in additive manufacturing processes. Within this range, some samples may be selected as the threshold qualities between useable, unusable, etc. Some powdered polymer materials, such as HP® 3D High Reusability PA 12 turn brown as they degrade and so it may be possible to arrange samples in terms of their brownness and then to decide which of the samples fall into which quality range. A loading process may be performed with each of these samples. Signals may be received from the color sensor indicative of the color of the powdered build material having a predetermined quality. The received signals may be assigned to a powder quality value based on the predetermined quality of the powdered build material. Wherein at least one of these received signals generated using the powder of predetermined quality may be used as a predetermined threshold. This allows future comparisons of received signals with the predetermined threshold to determine the quality of measured powder in relation to the quality of the measured samples.

The calibration discussed above, may also comprise measuring the samples under different conditions such as different powder flow rates in the transportation system, different lighting conditions, different measurement rates, or any other conditions or variables which may affect the measured signals from the color sensor.

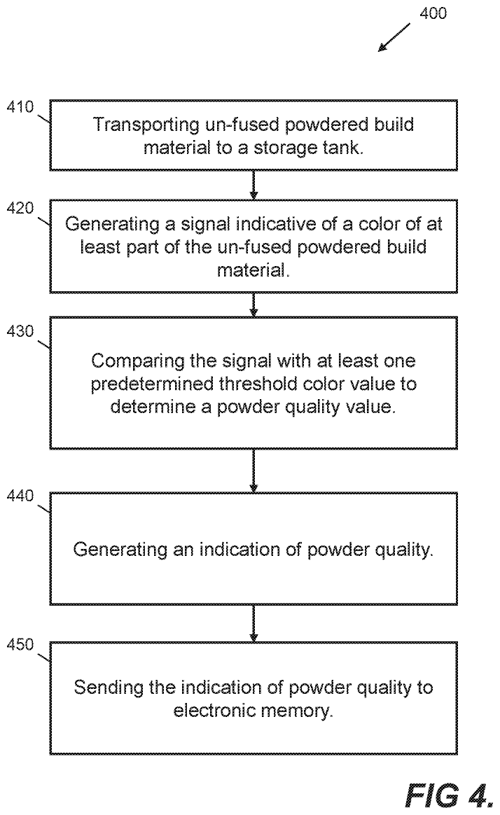

FIG. 4 shows a flow chart of an example method 400. At block 410 the method comprises transporting un-fused build material to a storage tank. As discussed above this may be implemented by a powdered build material transportation system. In some examples the un-fused powdered build material is transported at least partially through a hose. Hoses may be used in conjunction with pressure sources such as pumps, and valves in order to transport the powdered build material.

In some examples, transporting un-fused powdered build material to the storage tank comprises mixing un-fused powdered build material from at least two un-fused powdered build material tanks. In these examples, a mixing system may be used in conjunction with other components to mix the powdered build material from the at least two tanks and to transport it to the storage tank. In some examples at least one of the two un-fused powdered build material tanks is for storing un-fused powdered build material having been used in an additive manufacturing process. Un-fused powdered build material having been used in an additive manufacturing process is likely to have begun degrading due to the heating and cooling associated with such processes. Mixing un-fused powdered build material which has begun to degrade with fresh un-degraded powdered build material may mitigate the effects of using degraded powdered build material to generate objects in an additive manufacturing process. Using a higher proportion of fresh powdered build material in an additive manufacturing process may increase the structural integrity and ability to be colored of the generated objects.

At block 420 the method comprises generating a signal indicative of a color of at least part of the un-fused powdered build material. The signal may be generated at a color sensor positioned before, along, within or directly after the transportation system. The color sensor may not measure the color of all the un-fused powdered build material but may measure the color at regular intervals during the transportation of powdered build material to the storage tank. The color sensor may measure the average color of powdered build material passing in front of color sensor. The color sensor may not measure the color of all the particles of powdered build material passing in front of it due to the size and speed of the particles in the powder and the scattering of the light through the moving powder. However, the color sensor may be able to detect an average color of material passing in front of it.

At block 430 the method comprises comparing the signal with at least one predetermined threshold color value to determine a powder quality value. The at least one predetermined threshold color value may be a value relating to the color of powdered build material measured during a calibration process wherein the quality has been determined by another method. By comparing the signal generated from powdered build material in the present method with the predetermined threshold color value it may be possible to determine the color of the sample relative to the powdered build material measured during calibration. Therefore, it may be possible to determine the quality of the powdered build material being transported relative to the build material measured during the calibration. In some examples, each at least one predetermined threshold color value may be associated with a powder quality value. Powdered build material of a determined quality may be measured, and the resulting values may be used as the predetermined threshold color values.

At block 440 the method comprises generating an indication of powder quality. The indication of powder quality may be based on the comparison of the signal with the at least one predetermined color threshold value. The indication of powder quality may be binary. The indication of powder quality may be a non-binary indication of suitability of the un-fused powdered build material transported to the storage tank to be used in an additive manufacturing process. The number of possible values for the indicator may be dependent on the number of predetermined threshold color values, and powder qualities, against which the signal may be compared as well as the sensitivity of the color sensor. In an example, there are three possible values of powder quality determined by two predetermined threshold color values. A first powder quality, below the lower threshold, may indicate low quality and so the powder may not be usable in an additive manufacturing process in its current state. A second powder quality, above the higher threshold, may indicate high quality and so the powder may be usable without modification in an additive manufacturing process. A third powder quality, in between the two thresholds, may indicate recyclable quality. In some examples, the third powder quality may relate to powder which can be used in additive manufacturing processes where there is not a focus on part quality, structural integrity, or color. In some examples, the third powder quality may relate to powder which may be used in an additive manufacturing process but should be mixed with a portion, or a higher proportion if it has already been mixed, of fresh powdered build material.

At block 450 the method comprises sending the indication of powder quality to electronic memory. The electronic memory may be associated with the storage tank. Sending the indication of powder quality to electronic memory may comprise sending an electrical signal to electronic memory. The electronic memory may be memory in the storage tank. The storage tank may comprise a form of user interface such as a light, a touchscreen, or any other form of user interface such that it can display the indication of powder quality to the user. This may directly associate the indicator of powder quality with the powdered build material stored in the storage tank. The indication of powder quality may be sent to memory elsewhere in the system. For example, the indication may be sent to memory in the controller or ata user interface of the build material loading system. This may allow a user interface at the loading system to show the indication to a user. This may also allow the controller to react or take action based on the indication of powder quality.

In an example, the method may comprise comparing the indication of powder quality to additive manufacturing build process data to determine if the un-fused powdered build material transported to the storage tank is suitable for an additive manufacturing build process according to the additive manufacturing build process data, This may be used in examples where the controller of the storage tank loading system is also used to control a 3D printer, Another example in which this may be performed are examples where the indication of powder quality is written to electronic memory in the storage tank, The storage tank may be inserted or loaded into a 3D printer to begin an additive manufacturing process, The 3D printer may then read the indication of powder quality from the storage tank and compare the indication with a value in the additive manufacturing build process data which may specify a minimum or an ideal powder quality value. Depending on the result of this comparison the 3D printer may do at least one of perform a print process, not perform a print process, and indicate to a user the suitability of the powdered build material in the storage tank to perform the print process.

Certain examples described herein may increase the part quality and mechanical properties of objects generated in additive manufacturing processes. Powered build material quality may be determined by measuring the color powdered build material and determining the quality of the build material based on this color. This may be done automatically before using the powdered build material in a print process. These examples may also reduce the waste of powdered build material as the indication of powder quality may be used to determine which objects may be generated using different qualities of powder. Automatically determining the quality of powdered build material being loaded to a storage tank may help inform the user when to change the mix ratio between lower and higher quality powdered build material. This may be related to the density of objects in each build process. For example, when densely packing objects in a build process, un-fused powdered build material may degrade more quickly and a system according to the examples described herein may allow this to be identified and properties of the print processes to be altered accordingly. Some calibration processes within additive manufacturing systems may rely on powder dependent values such as irradiances, temperatures, and others. In these cases, determining precisely the quality of powder in the system, as may be done using the examples described herein, may increase the accuracy of these calibration processes.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A storage tank loading system for loading powdered build material to a storage tank, the storage tank loading system comprising at least:
a powdered build material tank for storing un-fused powdered build material having been used in an additive manufacturing process;
a powdered build material transportation system for transporting the un-fused powdered build material from at least the powdered build material tank to a storage tank;
a color sensor for detecting a color of at least part of the un-fused powdered build material transported to the storage tank by the powdered build material transportation system; and
a controller for receiving signals from the color sensor indicative of the color of the at least part of the un-fused powdered build material transported to the storage tank, to generate a quality indicator by comparing the received signals with at least one predetermined threshold value, and to send the quality indicator to electronic memory associated with the storage tank.

2. The storage tank loading system of claim 1, further comprising a powdered build material tank for storing un-fused powdered build material not having been used in an additive manufacturing process.

3. The storage tank loading system of claim 2, comprising a mixing system for mixing un-fused powdered build material from the powdered build material tank for storing un-fused powdered build material having been used in an additive manufacturing process with unfused powdered build material from the powdered build material tank for storing un-fused powdered build material not having been used in an additive manufacturing process.

4. The storage tank loading system of claim 1, wherein the color sensor is disposed on an outer side of an optically transmissive part of the hose.

5. The storage tank loading system of claim 1, comprising a user interface to display the quality indicator to a user.

6. A non-transitory computer readable storage medium comprising instructions that, when executed by a processor, cause the processor to:
begin a loading process to load powdered build material into a storage tank wherein at least a portion of the powdered build material has been used in an additive manufacturing process;
receive signals from a color sensor indicative of the color of the powdered build material being loaded to the storage tank;
compare the received signals with at least one predetermined threshold value to determine a powder quality value of the powdered build material being loaded into the storage tank;
with the powdered build material having been loaded into the storage tank, generate a quality indicator for the powdered build material loaded to the storage tank, wherein the quality indicator is based on the powder quality value; and
send the quality indicator to electronic memory associated with the storage tank.

7. The storage medium of claim 6, wherein the at least one predetermined threshold value is determined by:
beginning a loading process using powdered build material having a predetermined quality;
receiving signals from the color sensor indicative of the color of the powdered build material having a predetermined quality; and
assigning the received signals to a powder quality value based on the predetermined quality of the powdered build material.

8. The storage medium of claim 6, storing instructions that, when executed by the processor, cause the processor to send the quality indicator to a user interface for displaying the quality indicator to a user.

9. The storage medium of claim 8, wherein the quality indicator is none binary indicator of the suitability of the powdered build material loaded into the storage tank to be used in an additive manufacturing process.

10. A method comprising:
transporting un-fused powdered build material to a storage tank;
generating a signal indicative of a color of at least part of the un-fused powdered build material;
comparing the signal with at least one predetermined threshold color value to determine a powder quality value, wherein each at least one predetermined threshold color value is associated with a powder quality value;
generating an indication of powder quality based on the comparison of the signal with the at least one predetermined threshold color value; and
sending the indication of powder quality to electronic memory associated with the storage tank.

11. The method of claim 10, wherein the un-fused powdered build material is transported at least partially through a hose.

12. The method of claim 10, wherein transporting un-fused powdered build material to the storage tank comprises mixing un-fused powdered build material from at least two un-fused powdered build material tanks.

13. The method of claim 12, wherein at least one of the at least two un-fused powdered build material tanks is for storing un-fused powdered build material having been used in an additive manufacturing process.

14. The method of claim 10, wherein the indication of powder quality is a non-binary indication of suitability of the un-fused powdered build material transported to the storage tank to be used in an additive manufacturing process.

15. The method of claim 10, comprising comparing the indication of powder quality to additive manufacturing build process data to determine if the un-fused powdered build material transported to the storage tank is suitable for an additive manufacturing build process according to the additive manufacturing build process data.
